(19) United States
(12) Patent Application Publication
(10) Pub. No.: US 2011/0118371 A1
(43) Pub. Date: May 19, 2011

(54) RUBBER-MODIFIED FLAME-RETARDANT MOLDING COMPOUNDS

(75) Inventors: Maarten Staal, Durham, NC (US); Piyada Charoensirisomboon, Mannheim (DE); Norbert Güntherberg, Speyer (DE); Hartmut Heinen, Ludwigshafen (DE); Günter Kehr, Ludwigshafen (DE); Michel Pepers, Ludwigshafen (DE)

(73) Assignee: BASF SE, LUDWIGSHAFEN (DE)

(21) Appl. No.: 13/002,948

(22) PCT Filed: Jul. 3, 2009
(86) PCT No.: PCT/EP09/58390

§ 371 Date: Jan. 6, 2011

(30) Foreign Application Priority Data
Jul. 7, 2008 (EP) 08159798.1
Oct. 9, 2008 (EP) 08166227.2

(51) Int. Cl. C09K 21/14; C08K 3/32; C08K 5/521; C08K 5/5333; C08K 5/5397; C08L 25/00

(52) U.S. Cl. 521/139; 524/525; 524/417; 524/145; 524/414; 524/130; 524/139; 524/520

(57) ABSTRACT

The invention relates to thermoplastic molding compositions comprising
A) from 55 to 98% by weight of at least one vinylaromatic copolymer impact-modified with a particulate graft rubber,
B) from 1 to 44% by weight of a flame retardant comprising
   B1) an expandable graphite,
   B2) a phosphorus-comprising flame-retardant compound, and
   B3) a fluorine-comprising polymer,
C) from 1 to 20% by weight of a non-particulate rubber comprising polar groups, and
D) from 0 to 40% by weight of further additives,
   where the percentages by weight are in each case based on the total weight of components A) to D) and give a total of 100% by weight,
   and also to processes for the preparation of these molding compositions, to the use of these molding compositions for the production of moldings, of fibers, of foams, or of foils, and also to the resultant moldings, fibers, foams, and foils.

The invention relates to thermoplastic molding compositions comprising
A) from 55 to 98% by weight of at least one vinylaromatic copolymer impact-modified with a particulate graft rubber,
B) from 1 to 44% by weight of a flame retardant comprising
   B1) an expandable graphite,
   B2) a phosphorus-comprising flame-retardant compound, and
   B3) a fluorine-comprising polymer,
C) from 1 to 20% by weight of a non-particulate rubber comprising polar groups, and
D) from 0 to 40% by weight of further additives,
   where the percentages by weight are in each case based on the total weight of components A) to D) and give a total of 100% by weight.

The present invention also relates to processes for the preparation of these molding compositions, to the use of these molding compositions for the production of moldings, of fibers, of foams, or of foils, and also to the resultant moldings, fibers, foams, and foils.

Expandable graphite is known as a flame retardant in polystyrene (“PS”) or in impact-modified polystyrene (“HIPS”), for example from WO 03/046071 A1. According to that specification moreover, amounts of from 2 to 11%, calculated as halogen, of a halogen-comprising compound are needed as further flame retardant component. However, it is desirable, for example for reasons of toxicology, to minimize use of halogen-comprising flame retardants.

WO 00/34367 and WO 00/34342 disclose styrene polymers having a halogen-free flame retardant system and comprising expandable graphite and a phosphorus compound as flame retardant components. Molding compositions based on flame-retardant styrene polymers of this type are not fully satisfactory in relation to their drip behavior in the event of a fire, however.

WO 2005/103136 discloses flame-retardant styrene polymers which comprise not only expandable graphite and a phosphorus compound but also a further coadditive which is intended to suppress the migration of the phosphorus-comprising flame retardant to the polymer surface. Polycarbonate is explicitly mentioned as coadditive.

KR1996-0001006 discloses flame-retardant polystyrene where the flame retardant components comprise expandable graphite, a phosphorus compound, and Teflon. The average particle size of the expandable graphite is 5 μm. The amounts used of the Teflon added as antidrip agent are from 1 to 5 percent by weight. The resultant molding compositions having halogen-free flame retardant systems have good thermal stability and impact resistance.

Patent application EP 07112183.4 (file reference) describes acrylonitrile-styrene-acrylate polymers (“ASA”) and acrylonitrile-butadiene-styrene polymers (“ABS”) equipped with a flame retardant system comprising expandable graphite, a phosphorus compound, and Teflon, and moreover comprising linear styrene-butadiene block copolymers.

It was an object of the present invention to provide flame-retardant molding compositions which are based on vinylaromatic copolymers impact-modified with particulate graft rubbers, in particular based on ASA and/or ABS, and which, when compared with known molding compositions, have an improved combination of flame-retardant properties, and mechanical and rheological properties.

The molding compositions defined in the introduction have accordingly been found, and it is essential to the invention here that these comprise from 1 to 20% by weight, based on the total weight of components A) to D), of a non-particulate rubber comprising polar groups.

The flame-retardant molding compositions of the invention, based on vinylaromatic copolymers impact-modified with particulate graft rubbers, have, when compared with known molding compositions, an improved combination of flame-retardant properties, and mechanical and rheological properties.

A description follows of the molding compositions of the invention, and also of the processes and products which are further provided by the invention.

The molding compositions of the invention comprise
A) from 55 to 98% by weight, preferably from 57 to 92% by weight, particularly preferably from 60 to 85% by weight, of component A,
B) from 1 to 44% by weight, preferably from 5 to 40% by weight, particularly preferably from 10 to 35% by weight, of component B,
C) from 1 to 20% by weight, preferably from 3 to 18% by weight, particularly preferably from 5 to 15% by weight, of component C, and
D) from 0 to 40% by weight, preferably from 0 to 30% by weight, particularly preferably from 0 to 25% by weight, of component D,
   where the percentages by weight are in each case based on the total weight of components A) to D) and give a total of 100% by weight.

Flame retardant component B) in particular comprises
B1) from 20 to 79.99% by weight, preferably from 30 to 69.9% by weight, particularly preferably from 40 to 59.5% by weight, of component B1),
B2) from 20 to 79.99% by weight, preferably from 30 to 69.9% by weight, particularly preferably from 40 to 59.5% by weight, of component B2), and
B3) from 0.01 to 4% by weight, preferably from 0.1 to 3% by weight, particularly preferably from 0.5 to 2% by weight, of component B3),
   where the percentages by weight are in each case based on the total weight of components B1) to B3) and give a total of 100% by weight.

### Component A):

A suitable component A is in principle any of the vinylaromatic copolymers impact-modified with a particulate graft rubber. These vinylaromatic copolymers impact-modified with a particulate graft rubber, and their preparation, are known to the person skilled in the art and are described in the literature (by way of example in A. Echte, Handbuch der technischen Polymerchemie [Handbook of Industrial Polymer Chemistry], VCH Verlagsgesellschaft, Weinheim, 1993; and Saechtling, Kunststoff Taschenbuch [Plastics Handbook], Carl Hanser Verlag, Munich, 29th edition, 2004), and are commercially available.

Preferred components A) comprise, as rubber phase, a particulate graft rubber, and, as thermoplastic hard phase, copolymers composed of vinylaromatic monomers and of vinyl cyanides (SAN), in particular of α-methylstyrene and acrylonitrile, particularly preferably of styrene and acrylonitrile.

Component A) generally comprises from 15 to 60% by weight, preferably from 25 to 55% by weight, in particular from 30 to 50% by weight, of particulate graft rubber, and from 40 to 85% by weight, preferably from 45 to 75% by weight, in particular from 50 to 70% by weight, of vinylaromatic copolymers, where the percentages by weight are in each case based on the total weight of particulate graft rubber and of vinylaromatic copolymer and give a total of 100% by weight.

Preferred SAN impact-modified with a particulate graft rubber are acrylonitrile-styrene-acrylate polymers (“ASA”) and/or acrylonitrile-butadiene-styrene polymers (“ABS”), and also (meth)acrylate-acrylonitrile-butadiene-styrene polymers (“MABS”, transparent ABS), and also blends of SAN, ABS, ASA, and MABS with other thermoplastics, such as polycarbonate, polyamide, polyethylene terephthalate, polybutylene terephthalate, polyvinyl chloride, polyolefins, very particularly preferably with polycarbonate.

ASA polymers are generally understood to mean SAN polymers which have been impact-modified with a particulate graft rubber, and where elastomeric graft copolymers of vinylaromatic compounds, in particular styrene, and of vinyl cyanides, in particular acrylonitrile, are present on polyalkyl acrylate rubbers, in a copolymer matrix, composed in particular of styrene and/or α-methylstyrene and acrylonitrile. ASA polymers and their preparation are known to the person skilled in the art and described in the literature, for example in DIN EN ISO 6402-1 DE of February 2003, WO 02/00745, WO 00/11080, EP-A 450 485, and WO 2007/031445.

ABS polymers are generally understood to be impact-modified SAN polymers in which diene polymers, in particular 1,3-polybutadiene, are present in a copolymer matrix composed in particular of styrene and/or α-methylstyrene and acrylonitrile. ABS polymers and their preparation are known to the person skilled in the art and described in the literature, for example in DIN EN ISO 2580-1 DE of February 2003, WO 02/00745, and WO 2008/020012.

### Component B):

According to the invention, the thermoplastic molding compositions comprise, as component B), a flame retardant mixture comprising
B1) expandable graphite,
B2) a phosphorus-comprising flame-retardant compound, and
B3) a fluorine-comprising polymer.

The inventive molding compositions comprise, as component B1), expandable graphite known to the person skilled in the art and described in the literature (graphite expandable by using a certain amount of heat). This generally derives from natural or synthetic graphite.

The expandable graphite is obtainable by way of example by oxidation of natural and/or synthetic graphite. Oxidizing agents that can be used are H₂O₂ or nitric acid in sulfuric acid.

The expandable graphite can moreover be prepared via reduction, e.g. using sodium naphthalenide in an aprotic organic solvent.

The layer-lattice structure of graphite renders it capable of forming specific types of intercalation compounds. In these intercalation compounds, foreign atoms or foreign molecules have been absorbed, sometimes in stoichiometric ratios, into the spaces between the carbon atoms.

The surface of the expandable graphite can have been coated with a coating composition, for example with silane sizes known to the person skilled in the art, in order to improve compatibility with respect to the matrix of thermoplastic.

In the event that the expandable graphite has been obtained by the above-mentioned oxidation process, it can be necessary to add an alkaline compound, since the expandable graphite can otherwise cause corrosion of the molding compositions and/or of the production and storage apparatus used for such molding compositions (by virtue of the acid comprised). In particular, amounts of up to 10% by weight, preferably up to 5% by weight (based on 100% by weight of B1) can be added of alkali metal compounds, or else Mg(OH)₂, or Al hydroxides. Mixing advantageously takes place before the components are compounded.

The thermal expansion (specific volume change) of the expandable graphite on rapid heating from room temperature to 800° C. (in the direction of the c axis of the crystal) preferably amounts to at least 100 ml/g, preferably at least 110 ml/g.

An essential factor for suitability as flame retardant is that the expandable graphite does not expand to any great extent at temperatures below 270° C., preferably below 280° C. The person skilled in the art understands this to mean that the volume expansion of the expandable graphite at the temperatures mentioned is less than 20% over a period of 10 min.

The coefficient of expansion (as specific key variable) generally means the difference between the specific volume (ml/g) after heating and the specific volume at room temperature of 20° C. The following specification is usually used to measure this: a quartz container is heated to 1000° C. in an electric furnace. 2 g of the expandable graphite are rapidly placed in the quartz container and this is placed for 10 sec. in the furnace.

The weight of 100 ml of the expanded graphite is measured in order to determine the property known as “loosened apparent specific gravity”. The reciprocal is then the specific volume at this temperature. The specific volume at room temperature is correspondingly measured at 20° C. (Coefficient of expansion=specific volume after heating−specific volume at 20° C.).

The average particle size D₅₀ of the expandable graphite is preferably intended to be from 10 μm to 1000 μm, with preference from 30 μm to 850 μm, and particularly preferably from 200 μm to 700 μm. If the average particle sizes are lower, the result is generally insufficient flame-retardant action; if they are higher, the usual result is an adverse effect on the mechanical properties of the thermoplastic molding compositions.

The average particle size and the particle size distribution of the expandable graphite B1) can be determined from the cumulative volume distribution. The average particle sizes are in all cases the volume-average particle sizes determined by means of laser light scattering on a Malvern Mastersizer 2000, using the dry powder. The laser light scattering provides the cumulative distribution of the particle diameter of a specimen. From this it is possible to calculate the percentage of the particles whose diameter is equal to or smaller than a certain size. The average particle diameter, also termed the D₅₀ value of the cumulative volume distribution, is defined here as that particle diameter for which the diameter of 50% by weight of the particles is smaller than the diameter corresponding to the D₅₀ value. The diameter of 50% by weight of the particles is then likewise greater than the D₅₀ value.

The density of the expandable graphite is usually in the range from 0.4 to 2 g/cm³.

The phosphorus-containing compounds of component B2) are organic or inorganic compounds which comprise phosphorus, where the phosphorus has a valence state of from −3 to +5. For the purposes of the invention the valence state is the oxidation state as given in Lehrbuch der Anorganischen Chemie, by A. F. Hollemann and E. Wiberg, Walter des Gruyter and Co. (1964, 57th to 70th edition), pages 166-177. Phosphorus compounds of the valence states from −3 to +5 derive from phosphine (−3), diphosphine (−2), phosphine oxide (−1), elemental phosphorus (+0), hypophosphorous acid (+1), phosphorous acid (+3), hypodiphosphoric acid (+4) and phosphoric acid (+5).

Only a few examples will be mentioned from the large number of phosphorus-containing compounds suitable as component B2), in particular the inorganic or organic phosphates, phosphites, phosphonates, phosphate esters, red phosphorus, and triphenylphosphine oxide.

Examples of phosphorus compounds of the phosphine class, which have the valence state −3, are aromatic phosphines, such as triphenylphosphine, tritolylphosphine, trinonylphosphine, trinaphthylphosphine and trisnonylphenylphosphine. Triphenylphosphine is particularly suitable.

Examples of phosphorus compounds of the diphosphine class, having the valence state −2, are tetraphenyldiphosphine and tetranaphthyldiphosphine. Tetranaphthyldiphosphine is particularly suitable.

Phosphorus compounds of the valence state −1 derive from phosphine oxide.

Phosphine oxides of the general formula I are suitable compounds

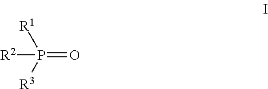

where R¹, R² and R³ in formula I are identical or different alkyl, aryl, alkylaryl or cycloalkyl groups having from 8 to 40 carbon atoms.

Examples of phosphine oxides are triphenylphosphine oxide, tritolylphosphine oxide, trisnonylphenylphosphine oxide, tricyclohexylphosphine oxide, tris(n-butyl)phosphine oxide, tris(n-hexyl)phosphine oxide, tris(n-octyl)phosphine oxide, tris(cyanoethyl)-phosphine oxide, benzylbis(cyclohexyl)phosphine oxide, benzylbisphenylphosphine oxide and phenylbis(n-hexyl)phosphine oxide. Other preferred compounds are oxidized reaction products of phosphine with aldehydes, in particular of tert-butylphosphine with glyoxal. Particular preference is given to the use of triphenylphosphine oxide, tricyclohexylphosphine oxide, tris(n-octyl)phosphine oxide or tris(cyanoethyl)phosphine oxide, in particular triphenylphosphine oxide.

Other suitable compounds are triphenylphosphine sulfide and its derivatives as described above for phosphine oxides.

Phosphorus of the valence state ±0 is elemental phosphorus. Red and black phosphorus can be used, and red phosphorus is preferred, particularly the surface-coated red phosphorus known to the person skilled in the art and described in the literature and commercially available as flame retardant for polymers.

Examples of phosphorus compounds of the oxidation state +1 are hypophosphites of purely organic type, e.g. organic hypophosphites such as cellulose hypophosphite esters and esters of hypophosphorous acids with diols, e.g. that of 1,10-dodecanediol. It is also possible to use substituted phosphinic acids and anhydrides of these, e.g. diphenylphosphinic acid. Other possible compounds are diphenylphosphinic acid, di-p-tolylphosphinic acid and dicresylphosphinic anhydride. Compounds such as the bis(diphenylphosphinic) esters of hydroquinone, ethylene glycol and propylene glycol, inter alia, may also be used. Other suitable compounds are aryl(alkyl)phosphinamides, such as the dimethylamide of diphenylphosphinic acid, and sulfonamidoaryl(alkyl)-phosphinic acid derivatives, such as p-tolylsulfonamidodiphenylphosphinic acid. Preference is given to use of the bis(diphenylphosphinic) ester of hydroquinone or of ethylene glycol, or bis(diphenylphosphinate) of hydroquinone.

Phosphorus compounds of the oxidation state +3 derive from phosphorous acid. Suitable compounds are cyclic phosphonates which derive from pentaerythritol, neopentyl glycol or pyrocatechol, for example compounds of the formula II

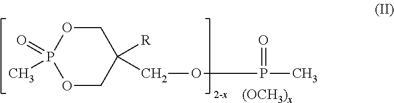

where R is a C₁-C₄-alkyl radical, preferably a methyl radical, and x is 0 or 1 (Amgard® P 45 from Albright & Wilson).

Phosphorus of the valence state +3 is also present in triaryl(alkyl)phosphites, such as triphenyl phosphite, tris(4-decylphenyl)phosphite, tris(2,4-di-tert-butylphenyl)phosphite and phenyl didecyl phosphite. It is also possible, however, to use diphosphites, such as propylene glycol 1,2-bis(diphosphite) or cyclic phosphites which derive from pentaerythritol, from neopentyl glycol or from pyrocatechol.

Particular preference is given to neopentyl glycol methylphosphonate and neopentyl glycol methyl phosphite, and also to pentaerythritol dimethyldiphosphonate and dimethyl pentaerythritol diphosphite.

Phosphorus compounds of oxidation state +4 which may be used are particularly hypodiphosphates, such as tetraphenyl hypodiphosphate and bisneopentyl hypodiphosphate.

Phosphorus compounds of oxidation state +5 which may be used are particularly alkyl- and aryl-substituted phosphates. Examples of these are phenyl bisdodecyl phosphate, phenyl ethyl hydrogenphosphate, phenyl bis(3,5,5-trimethylhexyl) phosphate, ethyl diphenyl phosphate, 2-ethylhexyl ditolyl phosphate, diphenyl hydrogenphosphate, bis(2-ethylhexyl) p-tolyl phosphate, tritolyl phosphate, bis(2-ethylhexyl) phenyl phosphate, di(nonyl) phenyl phosphate, phenyl methyl hydrogenphosphate, didodecyl p-tolyl phosphate, p-tolylbis(2,5,5-trimethylhexyl) phosphate and 2-ethylhexyl diphenyl phosphate. Particularly suitable phosphorus compounds are those in which each radical is aryloxy. Very particularly suitable compounds are triphenyl phosphate and resorcinol bis(diphenyl phosphate) and its ring-substituted derivatives of the general formula III (RDPs):

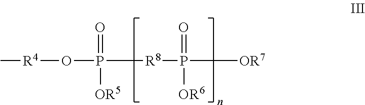

in which the definitions of the substituents in formula III are as follows:
R⁴-R⁷ are aromatic radicals having from 6 to 20 carbon atoms, preferably phenyl radicals, which may have substitution by alkyl groups having from 1 to 4 carbon atoms, preferably methyl,
R⁸ is a bivalent phenol radical, preferably

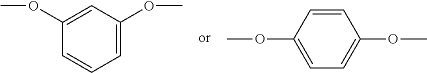

and n has an average value of from 0.1 to 100, preferably from 0.5 to 50, in particular from 0.8 to 10 and very particularly from 1 to 5.

Due to the process used for their manufacture, RPD products available commercially under the trade name Fyroflex® or Fyrol® RDP (Akzo) and also CR 733-S (Daihachi) are mixtures of about 85% of RDP (n=1) with about 2.5% of triphenyl phosphate and also about 12.5% of oligomeric fractions in which the degree of oligomerization is mostly less than 10.

It is also possible to use cyclic phosphates. Of these, diphenyl pentaerythritol diphosphate and phenyl neopentyl phosphate are particularly suitable.

Besides the low-molecular-weight phosphorus compounds mentioned above, it is also possible to use oligomeric or polymeric phosphorus compounds.

Polymeric, halogen-free organic phosphorus compounds of this type with phosphorus in the polymer chain are produced, for example, in the preparation of pentacyclic unsaturated phosphine dihalides, as described, for example, in DE-A 20 36 173. The molecular weight of the polyphospholine oxides, measured by vapor pressure osmometry in dimethylformamide, should be in the range from 500 to 7000, preferably from 700 to 2000.

Phosphorus here has the oxidation state −1.

It is also possible to use inorganic coordination polymers of aryl(alkyl)phosphinic acids, such as poly-β-sodium(I) methylphenylphosphinate. Their preparation is given in DE-A 31 40 520. Phosphorus has the oxidation number +1.

Halogen-free polymeric phosphorus compounds of this type may also be produced by the reaction of a phosphonic acid chloride, such as phenyl-, methyl-, propyl-, styryl- or vinylphosphonyl dichloride, with dihydric phenols, such as hydroquinone, resorcinol, 2,3,5-trimethylhydroquinone, bisphenol A, or tetramethylbisphenol A.

Other halogen-free polymeric phosphorus compounds which may be present in the novel molding compositions are prepared by reacting phosphorus oxytrichloride or phosphoric ester dichlorides with a mixture of mono-, di- or trihydric phenols and other compounds carrying hydroxy groups (cf. Houben-Weyl-Müller, Thieme-Verlag, Stuttgart, Germany, Organische Phosphorverbindungen Part II (1963)). It is also possible to produce polymeric phosphonates via transesterification reactions of phosphonic esters with dihydric phenols (cf. DE-A 29 25 208) or via reactions of phosphonic esters with diamines, or with diamides or hydrazides (cf. U.S. Pat. No. 4,403,075). However, the inorganic compound poly(ammonium phosphate) may also be used.

It is also possible to use oligomeric pentaerythritol phosphites, oligomeric pentaerythritol phosphates, and oligomeric pentaerythritol phosphonates according to EP-B 8 486, e.g. Mobil Antiblaze® 19 (registered trade mark of Mobil Oil) (see formulae IV and V):

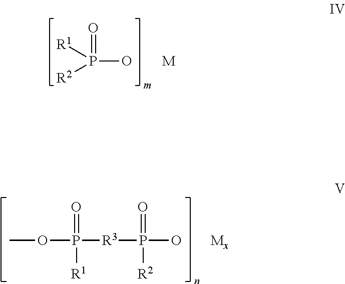

where the definitions of the substituents in the formulae IV and V are as follows:
R¹ and R² are hydrogen, C₁-C₆-alkyl, which, if appropriate, comprises a hydroxy group, preferably C₁-C₄-alkyl, linear or branched, e.g. methyl, ethyl, n-propyl, isopropyl, n-butyl, tert-butyl, n-pentyl; phenyl; where preferably at least one radical R¹ or R², and in particular R¹ and R², is/are hydrogen;
R³ is C₁-C₁₀-alkylene, linear or branched, e.g. methylene, ethylene, n-propylene, isopropylene, n-butylene, tert-butylene, n-pentylene, n-octylene, n-dodecylene;
arylene, e.g. phenylene, naphthylene; alkylarylene, e.g. methylphenylene, ethylphenylene, tert-butylphenylene, methylnaphthylene, ethylnaphthylene, tert-butylnaphthylene;
arylalkylene, e.g. phenylmethylene, phenylethylene, phenylpropylene, phenylbutylene;
M is an alkaline earth metal or alkali metal, Al, Zn, Fe, boron;
m is a whole number from 1 to 3;
n is a whole number of 1 and 3, and
x is 1 or 2.

Particular preference is given to compounds of the formula IV in which R¹ and R² are hydrogen, where M is preferably Ca, Zn, or Al, and very particular preference is given to the compound calcium phosphinate.

Products of this type are commercially available, e.g. as calcium phosphinate.

Examples of suitable salts of the formula IV or V in which only one radical R¹ or R² is hydrogen are salts of phenylphosphinic acid, its Na and/or Ca salts being preferred.

Further preference is given to salts which have an alkyl radical R¹ and/or R² comprising hydroxy groups. By way of example, these are obtainable by hydroxymethylation. Preferred compounds are Ca, Zn, and Al salts.

The average particle size D₅₀ of component B2) (measured by the method described above in relation to particle size determination for component B1)) is preferably smaller than 10 μm, preferably smaller than 7 μm, and in particular smaller than 5 μm. The D₁₀ value is preferably smaller than 4 μm, in particular 3 μm, and very particularly preferably smaller than 2 μm.

Preferred D₉₀ values are smaller than 40 μm and in particular smaller than 30 μm, and very particularly preferably smaller than 20 μm.

Further preference is given to phosphorus compounds of the general formula VI:

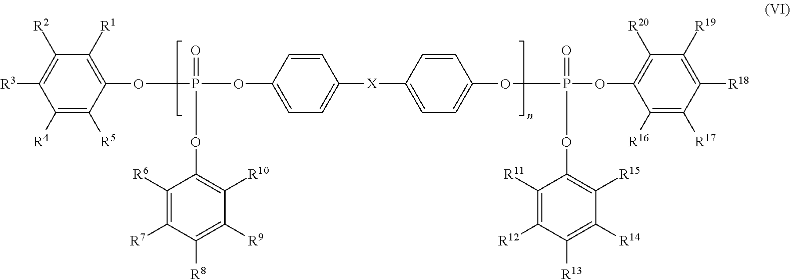

where the definitions of the substituents in formula VI are as follows:
R¹ to R²⁰, independently of one another, are hydrogen, or a linear or branched alkyl group up to 6 carbon atoms
n has an average value of from 0.5 to 50, and
X is a single bond, C═O, S, SO₂, or C(CH₃)₂

Preferred compounds B2) are those of formula VI in which R¹ to R²⁰, independently of one another, are hydrogen and/or a methyl radical. If R¹ to R²⁰, independently of one another, are a methyl radical, preference is given to those compounds in which the radicals R¹, R⁵, R⁶, R¹⁰, R¹¹, R¹⁵, R¹⁶, R²⁰ in ortho-position with respect to the oxygen of the phosphate group are at least one methyl radical. Preference is also given to compounds B2) in which one methyl group is present per aromatic ring, preferably in ortho-position, and the other radicals are hydrogen.

Particularly preferred substituents are SO₂ and S, and C(CH₃)₂ is very particularly preferred for X in the above formula (VI).

The average value of n in formula (VI) above is preferably from 0.5 to 5, in particular from 0.7 to 2, and in particular ≈1.

The statement of n as an average value is a consequence of the preparation process for the compounds listed above, the degree of oligomerization mostly being smaller than 10 and the content of triphenyl phosphate present being small (mostly <5% by weight), there being a difference here from batch to batch. Such compounds B2) are commercially available as CR-741 from Daihachi.

A very particularly preferred embodiment of the invention has proven to be the use of a mixture composed of red phosphorus and of at least one of the phosphorus compounds described above other than red phosphorus as component B2). One mixture particularly preferred as component B2) is composed of red phosphorus and of at least one inorganic or organic phosphate, phosphite, phosphonate, phosphate ester, or triphenylphosphine oxide. Particularly advantageous mixtures are those composed of red phosphorus and ammonium polyphosphate, of red phosphorus and bisphenol A bis(diphenyl phosphate), or of red phosphorus and triphenyl phosphate. One mixture very particularly preferred as component B2) comprises red phosphorus and ammonium polyphosphate. A mixture which is also very particularly preferred as component B2) is composed of red phosphorus and ammonium polyphosphate and triphenyl phosphate.

If the mixture mentioned composed of red phosphorus and of at least one of the phosphorus compounds described above other than red phosphorus is used as component B2), these molding compositions of the invention have an improved combination of flame-retardant properties and mechanical and rheological properties, and also in particular high heat resistance (Vicat temperature).

If the mixtures mentioned composed of red phosphorus and of at least one of the phosphorus compounds described above other than red phosphorus is used as component B2), component B2) generally comprises from 10 to 90% by weight, preferably from 20 to 80% by weight, particularly preferably from 30 to 70% by weight, of red phosphorus, and

from 10 to 90% by weight, preferably from 20 to 80% by weight, particularly preferably from 30 to 70% by weight, of at least one of the phosphorus compounds described above other than red phosphorus
where the percentages by weight of red phosphorus and of the at least one phosphorus compound described above other than red phosphorus are in each case based on the total weight of component B2) and give a total of 100% by weight.

The molding compositions comprise a fluorine-comprising polymer as component B3). Preference is given to fluorine-comprising ethylene polymers. These are polymers of ethylene whose fluorine content is from 55 to 76% by weight, preferably from 70 to 76% by weight.

Examples of these are polytetrafluoroethylene (PTFE) and tetrafluoroethylene-hexafluoropropylene copolymers, or tetrafluoroethylene copolymers with relatively small proportions (generally up to 50% by weight) of copolymerizable ethylenically unsaturated monomers. These are described by way of example by Schildknecht in “Vinyl and Related Polymers”, Wiley-Verlag, 1952, pages 484 to 494, and by Wall in “Fluorpolymers” [Fluoropolymers] (Wiley Interscience, 1972).

These fluorine-comprising ethylene polymers have homogeneous distribution in the molding compositions, and their average particle size D₅₀ is preferably in the range from 0.05 to 10 μm, in particular from 0.1 to 5 μm. These small particle sizes can particularly preferably be achieved via the use of aqueous dispersions of fluorine-comprising ethylene polymers, and incorporation of these into a polymer melt.

In one preferred embodiment of the invention, the proportion by weight of the fluorine-comprising polymer B3), based on the total weight of components A) to D), is from 0.01 to 0.5% by weight, preferably from 0.1 to 0.45% by weight, particularly preferably from 0.2 to 0.4% by weight.

### Component C):

A suitable component C) is in principle any of the non-particulate rubbers comprising polar groups and known to the person skilled in the art and described in the literature. Examples of components C) which are suitable according to the invention and which can be used are non-particulate rubbers which comprise polar groups and which have been crosslinked. However, preferred components C) are non-crosslinked rubbers comprising polar groups, and in particular linear rubbers comprising polar groups.

For the purposes of this invention, polar groups are preferably O- and/or N-comprising functional groups, in particular hydroxy, alkoxy, amino, imino, alkoxycarbonyl, carboxamide, and/or carboxy groups, and particularly preferably acid or ester groups which derive from acrylic acid or from maleic acid.

Ethylene-acrylate rubbers are particularly suitable as component C).

Preferred ethylene-acrylate rubbers are copolymers composed of ethylene and methyl acrylate, or in particular terpolymers composed of ethylene, methyl acrylate, and an unsaturated carboxylic acid; a suitable unsaturated carboxylic acid for the preparation of these terpolymers is maleic acid or its half-esters, and preferably acrylic acid.

The ethylene-acrylate rubbers can also be used as component C) in a form crosslinked, by way of example with diamines, in particular with hexane-1,6-diamine or 4,4′-methylenedianiline.

For the purposes of the present invention, particularly suitable ethylene-acrylate rubbers are commercially available as Elvaloy® 1330 EAC (DuPont).

### Component D):

The thermoplastic molding compositions can comprise, as component D), one or more additives different from components A), B), and C). In principle, any of the additives conventionally used for plastics and known to the person skilled in the art and described in the literature are suitable. For the purposes of the present invention, examples of additives conventionally used in plastics are stabilizers and oxidation retarders, agents to counteract decomposition by heat and decomposition by ultraviolet light, lubricants and mold-release agents, dyes and pigments, and plasticizers, and also fibers, such as glass fibers or carbon fibers.

Examples of oxidation retarders and heat stabilizers which can be added to the thermoplastic molding composition according to the invention are halides of metals of group I of the Periodic Table of the Elements, e.g. sodium halides, potassium halides, and lithium halides. It is moreover possible to use zinc fluoride and zinc chloride. Use can moreover be made of sterically hindered phenols, hydroquinones, substituted representatives of this group, or secondary aromatic amines, if appropriate in conjunction with phosphorus-comprising acids, or of salts of these, and mixtures of these compounds, preferably at concentrations of up to 1% by weight, based on the weight of the thermoplastic molding compositions.

Examples of UV stabilizers are various substituted resorcinols, salicylates, benzotriazoles, and benzophenones, the amounts of these generally used being up to 2% by weight, based on the weight of the thermoplastic molding compositions.

Lubricants and mold-release agents, the amounts of which generally added may be up to 1% by weight, based on the weight of the thermoplastic molding compositions, are stearic acid, stearyl alcohol, alkyl stearates, and stearamides, and also esters of pentaerythritol with long-chain fatty acids. It is also possible to use stearates of calcium, of zinc, or of aluminum, and also dialkyl ketones, e.g. distearyl ketone. Particularly suitable compounds according to the invention are zinc stearate, magnesium stearate, calcium stearate, and also N,N′-ethylenebisstearamide.

Glass fibers that can be used in the inventive molding compositions are any of the glass fibers known to the person skilled in the art and described in the literature (see by way of example Milewski, J. V., Katz, H. S. “Handbook of Reinforcements for Plastics”, pp. 233 et seq., Van Nostrand Reinholt Company Inc., 1987).

### Preparation Processes:

The inventive thermoplastic molding compositions can be prepared by processes known per se, by mixing the starting components in conventional mixing apparatuses, such as screw extruders, Brabender mixers, or Banbury mixers, and then extruding them. The extrudate can be cooled and comminuted. It is also possible to premix individual components and then to add the remaining starting materials individually and/or likewise in the form of a mixture. The mixing temperatures are generally from 200 to 280° C.

In one preferred method of operation, a first step can premix components B) and C). It is preferable to premix the entire component B) with at least a portion of component C) in the melt in a screw extruder. The premixed components B) and C) can either be compounded and, for example, pelletized, or else can be directly mixed in the form of a melt, for example in the same extruder, with component A) and, if appropriate, D) in a subsequent second step.

When the flame-retardant molding compositions of the invention, based on the on vinylaromatic copolymers impact-modified with particulate graft rubbers, are compared with known molding compositions, they have an improved combination of flame-retardant properties and mechanical and rheological properties.

Examples are used below for further explanation of the invention.

### EXAMPLES

### Test Methods

Notched Impact Resistance aₖ [kJ/m²]:

Notched impact resistance aₖ was determined to ISO 179 1eA(F) at 23° C.

Impact Resistance aₙ [kJ/m²]:

Notched impact resistance aₙ was determined to ISO 179 1eU at 23° C.

Flowability MVR [ml/10 min]:

Melt volume rate MVR 200/5 to DIN EN ISO 1133 was determined as a measure of flowability.

### Heat Resistance, Vicat B [° C.]:

Heat resistance was determined as Vicat softening point on standard small specimens at a heating rate of 50 K/h and with a force of 49.05 N to DIN 53460, Method B.

Afterflame Time t_{N} [s]:

The first afterflame time t1 was measured on specimens of thickness 1.6 mm after a first flame-application period of 10 seconds in the fire test based on UL 94, vertical burning standard. The flames were extinguished and then a second flame-application period of 10 seconds followed directly, after which the second afterflame time t2 was measured. The total of afterflame times t1 and t2 gives the afterflame time t_{N} (the value stated in each case being the average value of afterflame times t_{N} determined on two specimens).

### Starting Materials

Components or examples with prefix “V-” are non-inventive and serve for comparison.

### Polymer Component A):

Components A used were:

a-I: a commercially available acrylonitrile-butadiene-styrene copolymer (ABS), Terluran® HI10, from BASF SE, comprising a styrene-acrylonitrile copolymer hard phase and a particulate butadiene graft rubber.

### Flame Retardant Component B):

The component B1) used comprised:

b1-I: Nord-Min® 503 expandable graphite from Nordmann, Rassmann, GmbH, with average particle size D₅₀ of 465 μm, with free expansion (starting at about 300° C.) of at least 150 ml/g, and with bulk density of 0.5 g/ml at 20° C.

The component B2) used comprised:

b2-I: Disflammol® TP, a triphenyl phosphate from Lanxess Aktiengesellschaft.
b2-II: Nord-Min® JLS, an ammonium polyphosphate from Nordmann, Rassmann, GmbH.
b2-III: Exolit® RP 607, a red phosphorus from Clariant Produkte GmbH.

The component B3) used comprised:

b3-I: polytetrafluoroethylene PTFE TE-3893, Teflon® dispersion from C. H. Erbslöh with PTFE content of 60% by weight (based on the total weight of the dispersion).

### Rubber Component C):

Component C) used was:

c-I: a commercially available linear ethylene-methacrylate copolymer, Elvaloy® 1330 EAC, from DuPont.

The following comparative component V-C) was used:

V-c-II: a commercially available elastomeric styrene-butadiene-styrene block copolymer from BASF SE, marketed as Styroflex®.

### Further Additives D):

Component D) used was:

d-I: Acrawax® C, a commercially available N,N′-ethylenebisstearamide from Lonza Inc.
d-II: Black Pearls® 880, a commercially available carbon black from Cabot Corp.

### Preparation of Molding Compositions and Production of Moldings:

To determine the mechanical and rheological properties specified in table 1, components A) to D) (see table 1 for respective parts by weight) were homogenized in a ZSK30 twin-screw extruder from Werner & Pfleiderer at 220° C. and injection molded to give standard moldings.

To determine the fire properties specified in table 1, components A) to D) (see table 1 for respective parts by weight) were homogenized in a DSM midiextruder and extruded, using an injection-molding head, at a melt temperature of 240° C. and a mold-surface temperature of 80° C. to give test specimens to UL 94, vertical burning standard, with thicknesses of 1.6 mm.

TABLE 1
Constitution and properties of molding compositions (V prefix: for
comparison, nd: not determined)

| | Example | | | | | | | | | | |
|---|---|---|---|---|---|---|---|---|---|---|---|
| | 1 | V-2 | V-3 | 4 | V-5 | 6 | 7 | 8 | 9 | 10 | 11 |
| Constitution [parts by weight] | | | | | | | | | | | |
| a-I | 62.6 | 62.6 | 72.6 | 71.6 | 71.6 | 70.1 | 70.8 | 69.3 | 71.8 | 71.8 | 71.8 |
| b1-I | 15.0 | 15.0 | 15.0 | 8.0 | 8.0 | 8.0 | 8.0 | 8.0 | 8.0 | 8.0 | 8.0 |
| b2-I | 12.0 | 12.0 | 12.0 | — | — | — | — | — | — | 5.0 | 2.5 |
| b2-II | — | — | — | 5.0 | 5.0 | 5.0 | 5.0 | 5.0 | 5.0 | — | 2.5 |
| b2-III | — | — | — | 5.0 | 5.0 | 5.0 | 5.0 | 5.0 | 4.0 | 4.0 | 4.0 |
| b3-I | 0.4 | 0.4 | 0.4 | 0.4 | 0.4 | 0.4 | 0.4 | 0.4 | 0.4 | 0.4 | 0.4 |
| c-I | 10.0 | — | — | 10.0 | — | 10.0 | 10.0 | 10.0 | 10.0 | 10.0 | 10.0 |
| V-c-II | — | 10.0 | — | — | 10.0 | — | — | — | — | — | — |
| d-I | — | — | — | — | — | 1.5 | — | 1.5 | — | — | — |
| d-II | — | — | — | — | — | — | 0.8 | 0.8 | 0.8 | 0.8 | 0.8 |
| Properties | | | | | | | | | | | |
| Notched impact resistance aₖ | 12.6 | 10.9 | 6.4 | 9.0 | 6.9 | 11.6 | 8.6 | 8.7 | nd | 9.3 | 9.3 |
| at 23° C. [kJ/m²] | | | | | | | | | | | |
| Impact resistance aₙ at 23° C. | 28.7 | 26.0 | 16.6 | nd | nd | 32.9 | 26.6 | 28.3 | nd | nd | nd |
| [kJ/m²] | | | | | | | | | | | |
| Flowability MVR [ml/10 min] | 17.8 | 19.4 | 3.3 | 9.3 | 9.5 | 11.0 | 8.1 | 11.8 | 9.8 | 20.6 | 18.9 |
| Heat resistance, Vicat B, [° C.] | <50 | 54 | 58 | 76 | 81 | 70 | 80 | 77 | 82 | 75 | 80 |
| Afterflame time t_{N} [s] | 8.1 | 14.7 | 9.9 | 1.9 | 1.9 | 3.4 | 2.6 | 1.9 | 2.0 | nd | 7.2 |

The examples provide evidence that, when the flame-retardant molding compositions of the invention, based on vinylaromatic copolymers impact-modified with particulate graft rubbers, are compared with known molding compositions, they exhibit an improved combination of flame-retardant properties and mechanical and rheological properties.

1.-11. (canceled)

12. A thermoplastic molding composition comprising
A) from 55 to 98% by weight of at least one vinylaromatic copolymer impact-modified with a particulate graft rubber,
B) from 1 to 44% by weight of a flame retardant comprising
B1) from 20 to 79.99% by weight of an expandable graphite,
B2) from 20 to 79.99% by weight of a phosphorus-comprising flame-retardant compound, and
B3) from 0.01 to 4% by weight of a fluorine-comprising polymer,
where the percentages by weight are in each case based on the total weight of components B1) to B3) and give a total of 100% by weight, and
C) from 1 to 20% by weight of a non-particulate rubber comprising polar groups, and
D) from 0 to 40% by weight of further additives,
where the percentages by weight are in each case based on the total weight of components A) to D) and give a total of 100% by weight.

13. The thermoplastic molding composition according to claim 12, comprising an ethylene-acrylate rubber as component C).

14. The thermoplastic molding composition according to claim 12, comprising, as component A), acrylonitrile-styrene-acrylate polymers (“ASA”) and/or acrylonitrile-butadiene-styrene polymers (“ABS”).

15. The thermoplastic molding composition according to claim 12, comprising, as component B2), at least one compound selected from inorganic or organic phosphates, phosphites, phosphonates, phosphate esters, red phosphorus, and triphenylphosphine oxide.

16. The thermoplastic molding composition according to claim 12, comprising, as component B2), a mixture composed of red phosphorus and of at least one inorganic or organic phosphate, phosphite, phosphonate, phosphate ester, or triphenylphosphine oxide.

17. The thermoplastic molding composition according to claim 12, comprising, as component B2), a mixture composed of red phosphorus and ammonium polyphosphate.

18. The thermoplastic molding composition according to claim 12, comprising, as component B2), a mixture composed of red phosphorus and ammonium polyphosphate and triphenyl phosphate.

19. The thermoplastic molding composition according to claim 12, comprising a fluorinated ethylene polymer as component B3).

20. A process for the preparation of the thermoplastic molding compositions according to claim 12, which comprises mixing components A), B), C), and, if present, D) in the melt.

21. A fiber, a foil, a molding, or a foam obtainable from the thermoplastic molding compositions according to claim 12.
